(19) United States
(12) Patent Application Publication
(10) Pub. No.: US 2025/0216695 A1
(43) Pub. Date: Jul. 3, 2025

(54) DECOUPLED WAVEGUIDE EYEGLASS FRAME ASSEMBLY

(71) Applicant: GOOGLE LLC, Mountain View, CA (US)

(72) Inventors: Srivatsan Ravindran, San Jose, CA (US); Jerry Chung-Hung Chen, Castro Valley, CA (US); Peter Kossev, Mountain View, CA (US); Matthew Thomas Valente, Sunnyvale, CA (US)

(21) Appl. No.: 19/004,038

(22) Filed: Dec. 27, 2024

Related U.S. Application Data
(60) Provisional application No. 63/616,158, filed on Dec. 29, 2023.

(51) Int. Cl. G02C 5/00; G02B 27/01; G02C 9/00

(52) U.S. Cl. CPC G02C 5/00; G02B 27/017; G02C 9/00; G02B 2027/0178

(57) ABSTRACT

Decoupled waveguide eyeglass frame assemblies include an outer frame and an inner “floating” frame mounted to the outer frame at a central location proximal to a nose bridge of the outer frame. Waveguides and/or displays are mounted to the floating frame with upper and lower floating arms that act to ensure proper alignment of the one or more waveguides relative to another waveguide (e.g., in a binocular AR display) and/or to a user's eye.

### BACKGROUND

Binocular augmented reality (AR) or mixed reality (MR) eyeglasses often include dual AR displays (e.g., one display for each eye). The displays (e.g., waveguides that couple light from a light engine to an outcoupler proximal to a user's eye) typically need to be kept in proper alignment relative to one another to ensure proper depth perception and to avoid user discomfort that can result from improperly aligned displays, which can otherwise create a double vision effect or other unwanted distortions or effects. Any change in alignment can result in visual discomfort, and so mechanisms that help to maintain alignment between displays are an important design element of AR eyeglasses or other AR displays with binocular AR displays (e.g., AR goggles or heads-up displays, among others).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system that can be used with a decoupled waveguide eyeglass frame assembly in accordance with some embodiments.

FIG. 2 is a diagram illustrating a cross-section view of an example implementation of a waveguide in accordance with some embodiments.

FIG. 3 is a partial front view of a decoupled waveguide eyeglass frame assembly in an embodiment.

FIG. 4 is a partial rear view of a decoupled waveguide eyeglass frame assembly in an embodiment.

FIG. 5 is a rear view of a decoupled waveguide eyeglass frame assembly in an embodiment.

FIG. 6 is a partial rear view of a decoupled waveguide eyeglass frame assembly with extended upper floating arm in an embodiment.

FIG. 7 is a partial rear view of a decoupled waveguide eyeglass frame assembly with extended upper floating arm and shortened lower floating arm in an embodiment.

FIG. 8 is a partial rear view of a decoupled waveguide eyeglass frame assembly with shortened upper and lower floating arms in an embodiment.

FIG. 9 shows an example method of making a decoupled waveguide eyeglass frame assembly in accordance with some embodiments.

### DETAILED DESCRIPTION

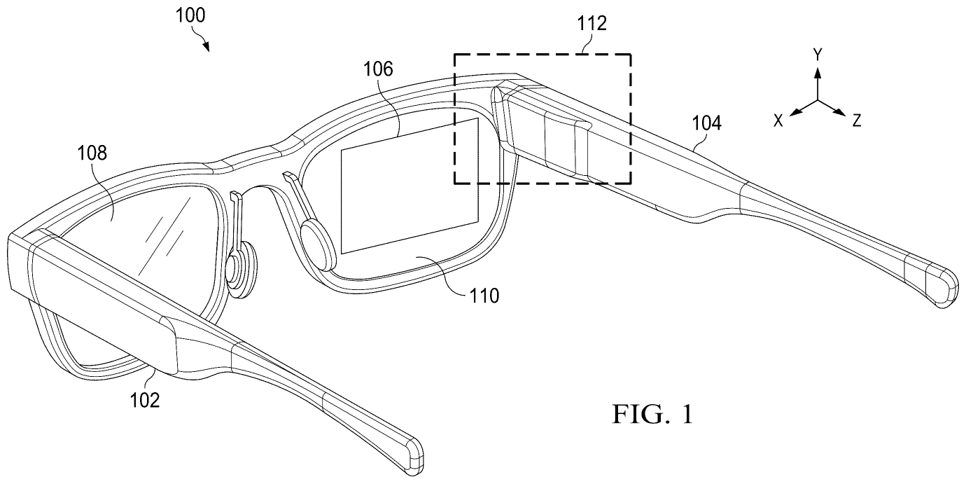

FIGS. 1-9 illustrate aspects of decoupled waveguide eyeglass frame assemblies in accordance with various embodiments. In some embodiments, a decoupled waveguide eyeglass frame assembly includes an outer frame to which an inner “floating” frame is mounted. The floating frame is mounted to the outer frame at a central location proximal to a nose bridge of the outer frame. One or more waveguides and/or displays are mounted to the floating frame with upper and lower floating arms that act to ensure proper alignment of the one or more waveguides relative to another waveguide (e.g., in a binocular AR display) and/or to a user's eye. By partially decoupling the waveguide from the outer frame using the inner floating frame, the waveguide can be kept in alignment with another waveguide and/or a user's eye reliably even if the outer frame is flexed or bent. Furthermore, the inner floating frame helps to protect the waveguide and any attached displays from damage in case the eyeglasses are dropped or otherwise subjected to otherwise potentially damaging forces or shocks. It is noted that even in a monocular AR display (e.g., AR eyeglasses where an AR display is only provided for one eye), an inner floating frame can help to maintain alignment of the waveguide with the user's eye and/or to protect the waveguide and/or attached displays from damage.

FIG. 1 illustrates an example display system 100 that can be used with a decoupled waveguide eyeglass frame assembly in accordance with some embodiments. It should be understood that the waveguide configurations of one or more embodiments are not limited to display system 100 of FIG. 1 and apply to other display systems. In at least some embodiments, the display system 100 comprises a support structure 102 that includes an arm 104, which houses a light engine or display configured to project images toward the eye of a user such that the user perceives the projected images as being displayed in a field of view (FOV) area 106 of a display at one or both of lens elements 108, 110. In the depicted embodiment, the display system 100 is a near-eye display system in the form of an eyewear display device that includes the support structure 102 configured to be worn on the head of a user and has a general shape and appearance of an eyeglass frame. The support structure 102 includes various components to facilitate the projection of such images toward the eye of the user, such as light engines, optical scanners, and/or waveguides. In at least some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a Wireless Fidelity (WiFi) interface, and the like.

Further, in at least some embodiments, the support structure 102 includes one or more batteries or other portable power sources for supplying power to the electrical components of the display system 100. In at least some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments, the display system 100 may have a different shape and appearance from the eyeglass frame depicted in FIG. 1.

In some embodiments, one or both of the lens elements 108, 110 are used by the display system 100 to provide an AR or MR display in which rendered graphical content is superimposed over or otherwise provided in conjunction with a real-world view as perceived by the user through the lens elements 108, 110. For example, display light used to form a perceptible image or series of images may be projected by a light engine of the display system 100 onto the eye of the user via a series of optical elements, such as a waveguide formed at least partially in the corresponding lens element, one or more scan mirrors, and/or one or more optical relays. Thus, one or both of the lens elements 108, 110 include at least a portion of a waveguide that routes display light received by an input coupler, or multiple input couplers, of the waveguide to an output coupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

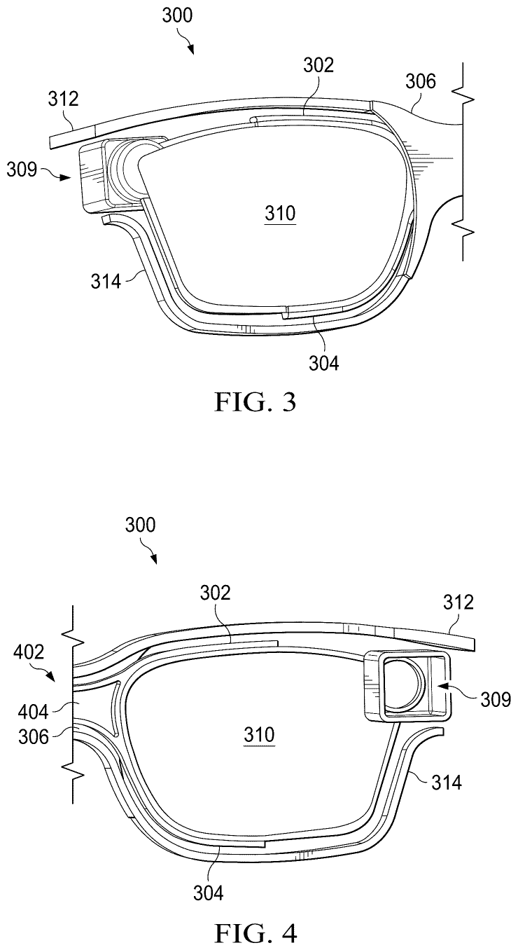

In some embodiments, as discussed further hereinbelow, the support structure 102 includes an internal frame structure (see, e.g., FIGS. 3-8) comprising a decoupled waveguide eyeglass frame assembly. The decoupled waveguide eyeglass frame assembly keeps waveguides in the lens elements 108, 110 in alignment with each other and/or a user's eye reliably even if the outer frame is flexed or bent. In at least some embodiments, the light engine is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The light engine, in at least some embodiments, includes multiple micro-LEDs. The light engine is communicatively coupled to a controller and a non-transitory processor-readable storage medium or memory storing processor-executable instructions and other data that, when executed by the controller, cause the controller to control the operation of the light engine. In at least some embodiments, the controller controls a scan area size and scan area location for the light engine and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

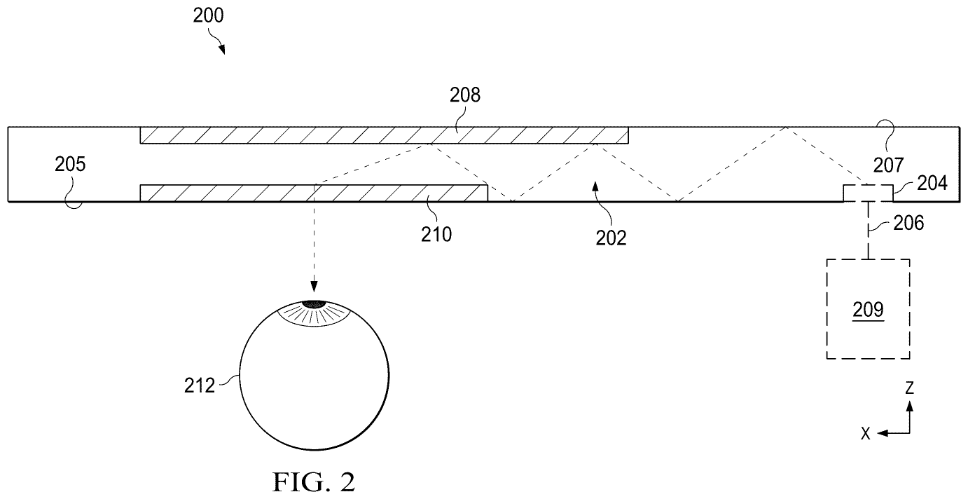

FIG. 2 depicts a cross-section view 200 of an implementation of a lens element 110 of a display system such as the display system 100 of FIG. 1. Note that for purposes of illustration, at least some dimensions in the Z direction are exaggerated for improved visibility of the represented aspects. In this example implementation, a waveguide 202, which may form a portion of the lens element 110 of FIG. 1, implements diffractive optical structures in a region 208 on the opposite side of the waveguide 202 as diffractive optical structures of a region 210. In particular, the reflective, refractive, or diffractive optical structures of an incoupler 204 are implemented on an eye-facing side 205 of the lens element 110. Likewise, the diffractive optical structures of region 210 (which provide outcoupler functionality) are implemented at the eye-facing side 205. Further in the illustrated implementation, the diffractive optical structures of region 208 (which provide EPE functionality) are implemented at a world-facing side 207 of the lens element 110 that is opposite the eye-facing side 205. Thus, under this approach, display light 206 from a light source 209 is incoupled to the waveguide 202 via the incoupler 204, and propagated (through total internal reflection in this example) toward the region 208, whereupon the optical structures of the region 208 diffract the incident display light for exit pupil expansion purposes, and the resulting light is propagated to the optical structures of the region 210, which output the display light toward a user's eye 212. In other implementations, the positions of regions 208 and 210 may be reversed, with the diffractive optical structures of region 210 formed on the world-facing side 207 and the diffractive optical structures of region 208 formed on the eye-facing side 205, however, this may result in the regions 208 and 210 having different positions, dimensions, and shapes, and also may require diffractive optical structures in each region to have different characteristics. It is noted that, in general, one or more waveguides used in the display system 100 may be diffractive, reflective, and/or refractive.

FIG. 3 is a partial front view of a decoupled waveguide eyeglass frame assembly 300 in an embodiment. In some embodiments, the support structure 102 of the display system 100 of FIG. 1 includes an internal frame structure comprising the decoupled waveguide eyeglass frame assembly 300. As shown in FIG. 3, in some embodiments, an inner floating frame includes an upper floating arm 302 and a lower floating arm 304 that together secure a lens element 310 (which may include a waveguide) and a display 309 (e.g., a light engine, which is attached to the lens element 310 in this embodiment using, e.g., glue) in proper alignment relative to a user's eye and/or another waveguide associated with the opposite eye in AR eyeglasses. As the inner floating frame is partially decoupled from an outer frame 306 with space, spacing, free space, or a gap between the outer frame 306 and the inner floating frame, the floating frame, the lens element 310, and the attached display 309 are able to move slightly relative to the outer frame 306. Notably, in some embodiments, the outer frame 306 is made with a relatively more flexible polymer or plastic, while the inner floating frame is made with a relatively more stiff, rigid polymer or metal. By using a lighter weight, more flexible material for the outer frame 306 and a stronger material for the inner floating frame, proper alignment of the waveguide can be ensured with high confidence while maintaining a relatively low overall product weight. In some embodiments, the outer frame 306 includes an upper static arm 312 and a lower static arm 314.

FIG. 4 illustrates a partial rear view of the decoupled waveguide eyeglass frame assembly 300 of FIG. 3 in accordance with some embodiments, showing a single contact point or region between the inner floating frame, generally indicated at 402, and the outer frame 306 in the nose bridge region 404. In some embodiments, the inner floating frame 402 and the outer frame 306 are attached to one another at the nose bridge region 404 using glue or another adhesive or attachment mechanism. As flex forces in the nose bridge region 404 are typically minimal in normal use, this design enables the inner floating frame 402 to act like a spring in some circumstances, absorbing shock from drop tests and/or enabling a more lightweight overall eyeglass frame to pass safety or compliance tests. In some embodiments, one or more of the upper static arm 312, the lower static arm 314, and a portion of the outer frame 306 in the nose bridge region 404 is attached to the support structure 102 of the display system 100 of FIG. 1.

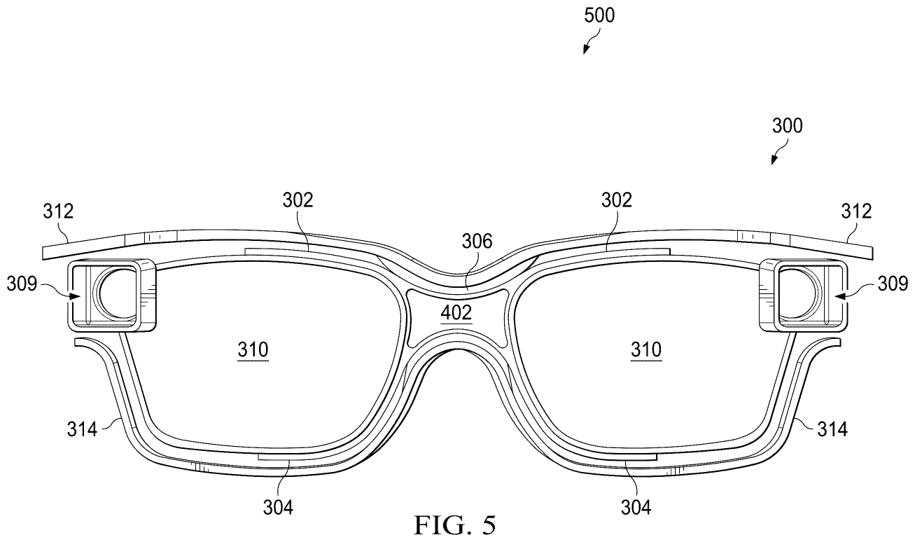

FIG. 5 is a rear view of a decoupled waveguide eyeglass frame assembly 500 in an embodiment. In some embodiments, the support structure 102 of the display system 100 of FIG. 1 includes an internal frame structure comprising the decoupled waveguide eyeglass frame assembly 500. FIG. 5 illustrates the decoupled waveguide eyeglass frame assembly 300 of FIGS. 3 and 4 in a full rear view, showing how the upper floating arms 302 and lower floating arms 304 of the inner floating frame 402 to which the lens elements 310 are attached maintain alignment of the lens elements 310 relative to each other and/or a user's eye in order to ensure an optimal AR display. In some embodiments, the inner floating frame 402 is glued, press-fit, or otherwise secured to the outer frame 306 proximal to a nose bridge region of the outer frame 306 (see, e.g., nose bridge region 404 of FIG. 4), while in other embodiments the outer frame is overmolded onto the inner floating frame. Notably, in some embodiments, one or more of the outer frame and inner floating frame are manufactured using 3D printing techniques (e.g., additive or subtractive manufacturing, among others).

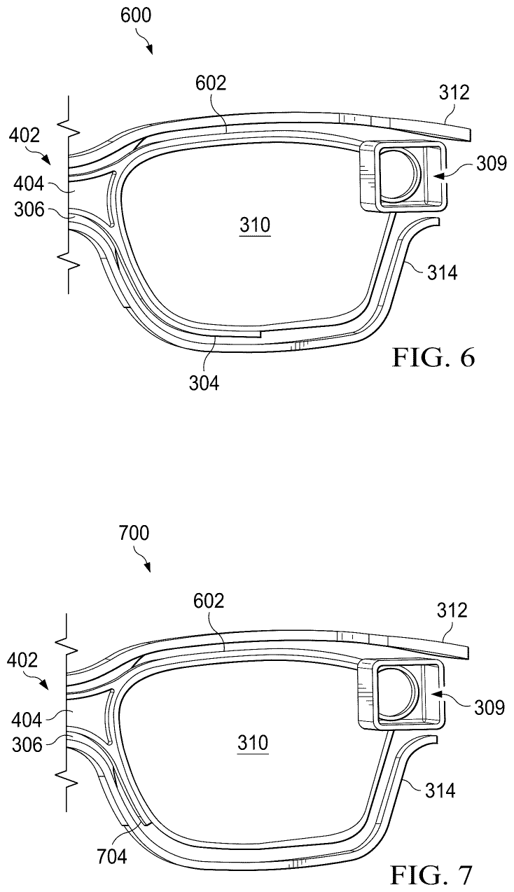

FIG. 6 is a partial rear view of a decoupled waveguide eyeglass frame assembly 600 with extended upper floating arm 602 in an embodiment. In some embodiments, the support structure 102 of the display system 100 of FIG. 1 includes an internal frame structure comprising the decoupled waveguide eyeglass frame assembly 600. FIG. 6 illustrates how the upper floating arm 602 of the inner floating frame 402 can be extended relative to the upper floating arms 302 shown in FIGS. 3-5 in order to increase the rigidity of the floating frame, although this may also result in an increased overall product weight.

FIG. 7 is a partial rear view of a decoupled waveguide eyeglass frame assembly 700 with extended upper floating arm 602 and shortened lower floating arm 704 in an embodiment. In some embodiments, the support structure 102 of the display system 100 of FIG. 1 includes an internal frame structure comprising the decoupled waveguide eyeglass frame assembly 700. FIG. 7 illustrates how the lower floating arm 704 of the inner floating frame can be shortened relative to the lower floating arms 304 shown in FIGS. 3-5 in order to reduce overall product weight relative to an embodiment like that shown in FIG. 6.

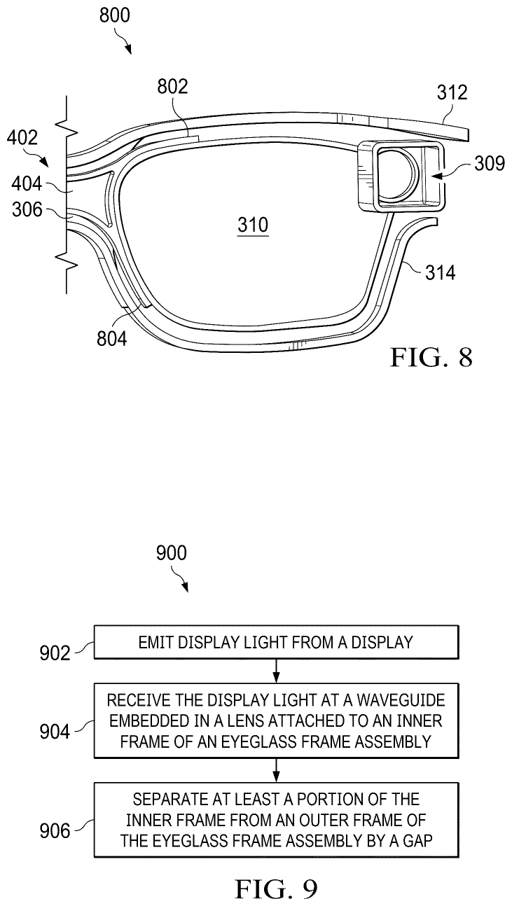

FIG. 8 is a partial rear view of a decoupled waveguide eyeglass frame assembly 800 with a shortened upper floating arm 802 and a shortened lower floating arm 804 in an embodiment. In some embodiments, the support structure 102 of the display system 100 of FIG. 1 includes an internal frame structure comprising the decoupled waveguide eyeglass frame assembly 800. FIG. 8 illustrates how the upper floating arm 804 and lower floating arm 806 of the inner floating frame 402 can be shortened relative to the upper floating arms 302 and lower floating arms 304 shown in FIGS. 3-5 to reduce overall product weight, although this may reduce the ability for the inner floating frame to maintain proper alignment of the waveguide relative to a user's eye and/or another waveguide associated with the opposite eye. Generally, the shorter the floating arms of the inner floating frame, the stiffer or stronger the material from which the floating arms will typically need to be in order to ensure proper alignment of the waveguide with the same degree of confidence as an embodiment with longer floating arms.

FIG. 9 is a flow diagram of a method 900 of manufacturing a decoupled waveguide eyeglass frame assembly such as the assembly 300 of FIG. 3, the assembly 500 of FIG. 5, the assembly 600 of FIG. 6, the assembly 700 of FIG. 7, or the assembly 800 of FIG. 8 in accordance with some embodiments. At block 902, a display, such as the light source 209 of FIG. 2, emits display light. At block 904, a waveguide, such as the waveguide 202 of FIG. 2, embedded in a lens attached to an inner frame of an eyeglass frame assembly, such as one of the assemblies of FIGS. 3-8, receives the display light. At block 906, at least a portion of the inner frame is separated from an outer frame of the eyeglass frame assembly by a gap. In some embodiments, the material of the outer frame has a lower stiffness or stiffness-to-mass ratio than the material of the inner frame.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyeglass frame assembly, comprising:
an outer frame;
an inner frame attached to the outer frame; and
a lens comprising a waveguide attached to the inner frame,
wherein at least a portion of the outer frame is separated from at least a portion of the inner frame by a gap.

2. The assembly of claim 1, wherein the gap is between at least a portion of the outer frame and at least a portion of the lens.

3. The assembly of claim 1, wherein the inner frame is attached to the outer frame proximal to a nose bridge of the outer frame and the inner frame is otherwise decoupled from the outer frame.

4. The assembly of claim 1, further comprising a display configured to project images via the waveguide.

5. The assembly of claim 4, wherein the display is attached to the lens.

6. An eyewear display device, comprising:
an outer frame;
an inner frame attached to the outer frame;
a display; and
a lens comprising a waveguide attached to the inner frame,
wherein the display is attached to the lens and at least a portion of the outer frame is separated from at least a portion of the inner frame.

7. The device of claim 6, wherein at least a portion of the outer frame is separated from at least a portion of the lens.

8. The device of claim 6, wherein the inner frame is attached to the outer frame proximal to a nose bridge of the outer frame, and the inner frame is otherwise decoupled from the outer frame.

9. A method, comprising:
directing display light from a display through a waveguide embedded in a lens attached to an inner frame of an eyeglass frame assembly, wherein the inner frame is attached to an outer frame of the eyeglass frame assembly and wherein at least a portion of the outer frame is separated from at least a portion of the inner frame by a gap.

10. The method of claim 9, wherein the inner frame is attached to the outer frame proximal to a nose bridge of the outer frame, and the inner frame is otherwise decoupled from the outer frame.
